(19) United States
(12) Patent Application Publication
(10) Pub. No.: US 2018/0055024 A1
(43) Pub. Date: Mar. 1, 2018

(54) Buzz Bait

(71) Applicant: John Webber, Panasoffkee, FL (US)

(72) Inventor: John Webber, Panasoffkee, FL (US)

(21) Appl. No.: 15/253,621

(22) Filed: Aug. 31, 2016

(51) Int. Cl. A01K 85/10

(52) U.S. Cl. CPC A01K 85/10

(57) ABSTRACT

A buzz bait, wrapped in stranded colored plastic, and incorporating a keeper which protrudes downward and rearwardly from the buzz blade until ends on the same plane and aligned with the barb of the hook. This keeper allows the head of an artificial bait to be connected to the keeper and the rearward end of the artificial bait to be hook so that only the tip of the hook protrudes from the artificial bait, significantly reducing the potential for the hook to become ensnared in foliage. The colored plastic wrap reinforces and stiffens the body of the lure preventing deformation when force is applied to the lure and increases the attractiveness of the lure to the fish.

### CROSS-REFERENCE TO RELATED APPLICATIONS

None

### FIELD OF INVENTION

The present invention relates generally to apparatus for fishing, trapping and vermin destroying and, more particularly, to artificial fishing baits with movably connected rigid lure members commonly known as Buzz Baits.

### BACKGROUND

The use of artificial lures is a traditional method for attracting and catching fish. Fishing lures having spinners that are reciprocated or rotated during trolling have come to be known in the trade as a spinner bait. Many game fish find the sight of churning water and wiggling filaments to be an irresistible inducement to strike.

One popular and effective top-water spinner lure, the buzz-bait, includes a wire body with a water-churning propeller at one end and a fishhook hidden by a number of wiggling filaments at the other. The water-churning propeller(s) are rotatable on one portion of a frame of a lure that is spaced apart from a second portion of the lure having an imitation fish head and hook.

A typical buzz bait comprises a wire frame including upper and lower frame members which extend rearwardly from an eye in a diverging relationship and the two frame members will eventually run parallel to each other. The eye is adapted to have a fishing line secured thereto in conventional fashion. Buzz blades are rotatably attached to the upper frame member parallel to the lower frame member. A weight is affixed to the rearward end of lower frame member and usually is shaped and colored to resemble a bait fish. A fish hook extends rearwardly from weight with strands or filaments extending rearwardly from weight to camouflage fish hook. Artificial bait such as a plastic frog or worm can be affixed to the hook to further attract fish.

Although the prior art buzz bait lure does satisfactorily perform, there are several deficiencies in its performance that could be remedied, specifically when the device is utilized in waters where lily pads and seaweeds may be present.

First, the current embodiment of the devices does not allow the for the lure to be baited with secondary artificial baits that will allow the lure function weedlessly when utilized in waters where weeds and lily pads may be present.

Secondly, the wire construction of the buzz bait leaves the device susceptible to damage, particularly when the lure is caught in lily pads and seaweeds and needs to be broken free. The lures need to be constructed of thin wires to better hide the device from the fish, but the thin wire can easily be deformed when forcefully freeing the lure from lily pads and seaweeds.

### SUMMARY

The aim of this invention is to build a buzz bait lure which can be baited with secondary artificial baits that will allow the lure effectively function weedlessly when utilized in waters where weeds and lily pads may be present as well as be robust enough to allow the device to be forcefully freed from weeds and lily pads without deforming the lure in the event that the lure does become ensnared in these foliage.

This device achieves the goal of allowing the lure to effectively operate weedlessly by incorporating a keeper which protrudes downward and rearwardly from the buzz blade until ends on the same plane and aligned with the barb of the hook. This keeper allows the head of an artificial bait to be connected to the keeper and the rearward end of the artificial bait to be hook so that only the tip of the hook protrudes from the artificial bait, significantly reducing the potential for the hook to become ensnared in foliage.

This device achieves the goal of preventing deformation of the lure in the event the lure needs to be forcefully freed from weeds and lily pads by wrapping the lure wire in a stringed colored plastic wrap. The colored plastic wrap reinforces and stiffens the body of the lure preventing deformation when force is applied to the lure. The use of colored plastic provides the additional benefit of making the lure more attractive the fish, increasing its fish trapping effectiveness in addition to strengthening the lure.

### BRIEF DESCRIPTION OF THE DRAWINGS

FIG. 1 is a side view of the preferred embodiment of the buzz bait.

FIG. 2 is a perspective view of the preferred embodiment of the buzz bait.

FIG. 3 is a side view of the preferred embodiment of the buzz bait with an artificial worm attached.

FIG. 4 is a perspective view of the preferred embodiment of the buzz bait with an artificial worm attached.

FIG. 5 is a is a perspective view of the preferred embodiment of the buzz bait with an artificial frog attached

FIG. 6 is a side view of an alternate embodiment of the buzz bait.

### DETAILED DESCRIPTION OF THE INVENTION AND PREFERRED EMBODIMENT

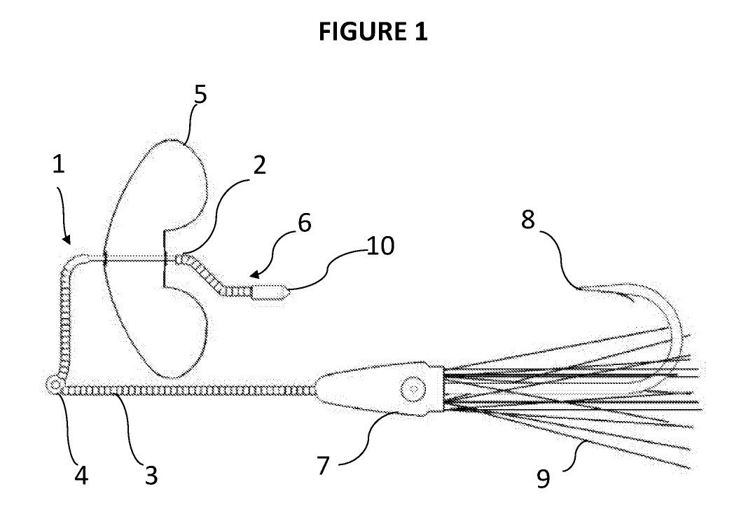

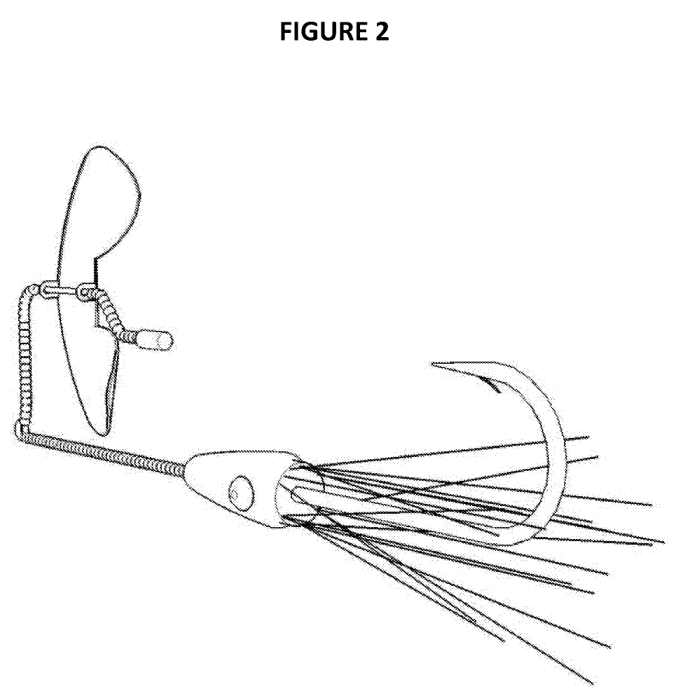

Referring to FIG. 1, the buzz bait of the preferred embodiment of the current invention generally comprises a frame 1, including upper 2 and lower 3 frame members, which extend rearwardly from an eye 4 in a diverging relationship and the upper 2 and lower 3 frame members will eventually run parallel to each other, a buzz blade 5, which is rotatably attached to said upper frame member 2 parallel to the lower frame member 3, a keeper 6 which protrudes from said upper frame member 2 downward and rearwardly, a weighted bait body 7 is affixed to the rearward end of lower frame member 3, a fish hook 8 which extends rearwardly from the weighted bait body 7, and strands or filaments 9 extending rearwardly from weighted bait body 7.

The lure frame 1 is comprised of a round metal wire, substantially wrapped in colored strands of plastic, however, the portion of the upper frame member 2 where the buzz blade 5 is located, would typically not wrapped in plastic. Once the plastic has been wrapped around round metal wire, the plastic is heated, typically with a heat gun, to the point where it melts and adheres to itself and the round metal wire. The application of the wire to the round metal frame provides multiple improvements over the prior arts. Firstly, the wrapping stiffens and strengthens the entire, making less susceptible to deformation. Secondly, the coloring of the wrapping will make the lure more visible and attractive to the fish than thin metal wire alone, and allows the fisherman to utilize different colored baits to adjust for the weather. Thirdly, the plastic wrap eliminates the need for bearings (not pictured), which are typically used to restrict the movement of the buzz blade 5 along the upper frame member 2.

The lure eye 4 is located that the forward most point of the lure and is utilized for receiving one end of a fishing line. In the preferred embodiment of the invention, the lure eye 4 is formed by the lure frame wire 1 having a “C” shaped protrusion at the forward most point of the lure where the lower 3 frame member begins. When the plastic is wrapped around the wire it is done is such a manner that eye is lure eye 4 is completely enclosed so that the fishing line cannot slide out if the lure eye 4 when attached to the lure.

The lure frame 1 is comprised of upper 2 and lower 3 frame members which extend rearwardly from the lure eye 4 in a diverging relationship, and following the divergence of the two members from each other, travel rearwardly in a parallel manner. The minimum distance between the parallel upper 2 and lower members 3 is at least the radius of the buzz blade 5.

Attached to the upper frame member 2, is a buzz blade 5. The wire of the upper frame member 2, is run through the two receiving holes in center of the buzz blade 5, which allows the buzz blade 5, to freely rotate around the upper frame member 2 as the lure is retrieved in the water. The buzz blade 5 is linearly captured in place and prevented from excessively sliding about the upper frame member 2 by the aforementioned plastic wrapping, assuming the diameter of the wrapped wiring is larger than the diameter of the two receiving holes in center of the buzz blade 5. Alternatively, a number of bearings could be utilized to linearly capture the buzz blade 5.

There are number of different types of buzz blades that are currently available. Buzz blades are available in 2, 3, and 4 blade versions. For buzz bait blade sizes determine how fast and deep the lure will run. In a general comment, the bigger the blade the slower it will run and the slower it will sink. Additionally, some buzz baits utilize more than one buzz blade. In the preferred embodiment of the invention a buzz blade 5 utilized is a single propeller style blade, however, it is contemplated that any style or number of buzz blades could be utilized with this invention.

Integrated into the upper frame member 2, and protruding rearward and downward from the buzz blade is a keeper 6. The keeper is made of wire, and can be wrapped in colored strands of plastic as previously discussed. At the most rearward tip of the keeper 6 is a means for retaining the front ends of artificial lures 10. The keeper functions to provide a retaining function for the head section 101 of the artificial lure 100. Additionally, the means for retaining the front ends of artificial lures 10 should be aligned with the hook 8, so that when the artificial lure is attached to the buzz bait, the artificial lure is parallel with the upper 2 and lower 3 frame members, and laterally aligned with the frame 1 as well. In the preferred embodiment the means for retaining the front ends of artificial lures 10 is simply the frame 1 itself, however, it is contemplated that a more robust (but possibly more costly) solution could be achieved in a number of manners, such as another hook, a barb, a threaded tip, etc.

A weighted bait body 7 is attached to the rearward most point of the lower frame member 3. The weighted bait body may be painted to further increase the attractiveness of the lure to the fish.

Attached to the weighted bait body 7 is the hook 8 which is upwardly and inwardly mounted so as to have its point placed within the area between the upper 2 and lower 3 frame members. Additionally the hook should be aligned laterally so that it is generally aligned with the lure frame 1.

Strands or filaments 9 extend rearwardly from weighted bait body 7. The strands or filaments 9 can be affixed to the weighed body 7 in any manner known to those skilled in the art including banding the strands or filaments 9 to a receiving aperture (not pictured) on the weighed body 7. The strands or filaments 9 function to attract fish because of the movement thereof as the lure is retrieved. The Strands or filaments 9 also function as a screen for the hook so that the hook is hidden from the view of the fish as well as preventing weeds from becoming ensnared in the hook.

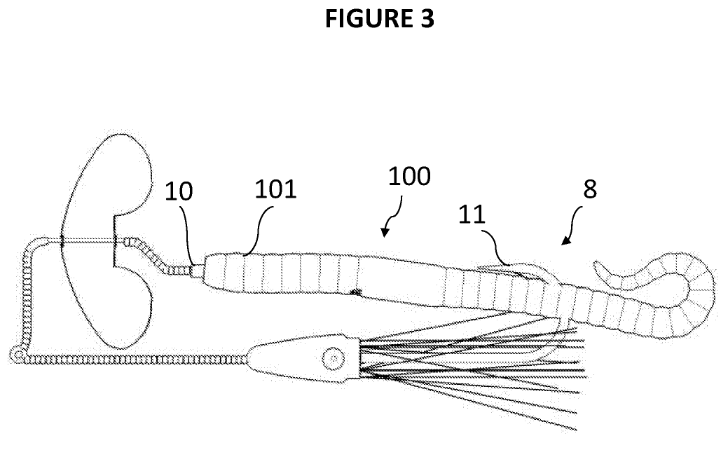

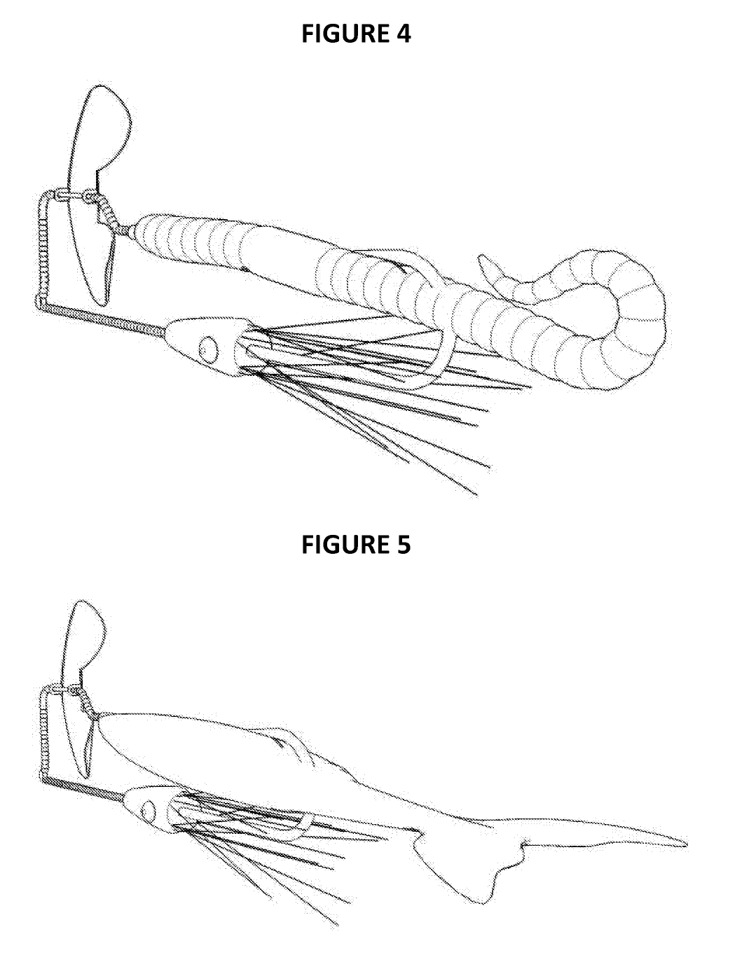

Referring to FIG. 3, when utilized, an artificial lure 100, such as a plastic worm or plastic frog is baited on the lure. The head of the artificial lure 101, is affixed to the keeper 6 means for retaining the front ends of artificial lures 10. In the preferred embodiment the head of the artificial lure 101 is simply pushed with force means for retaining the front ends of artificial lures 10 until the means is pushed inside of the artificial lure 100 sufficiently deep that it cannot be easily dislodged.

Once the head of the artificial lure 101, is affixed to the keeper 6 via the means for retaining the front ends of artificial lures 10 the hook 8 is inserted into the artificial lure 100, in a manner such that the only the tip of the hook 11, protrudes from the body of the artificial lure 100.

Baiting the lure in this manner is an improvement over the prior arts because it allows the artificial lure 100 to remain aligned with the rest of the lure frame 1 while still ensuring that only a minimal portion of the hook is exposed to accidentally ensnare weeds or lily pads during operation. Keeping the artificial lure 100 aligned with the rest of the lure frame 1 is important because it makes the lure more natural looking to the fish. Additionally, baiting the lure in this manner is an improvement over the prior arts because it create two attachment points for the artificial lure 100, reducing the likelihood of the artificial lure 100 shifting on the lure during use.

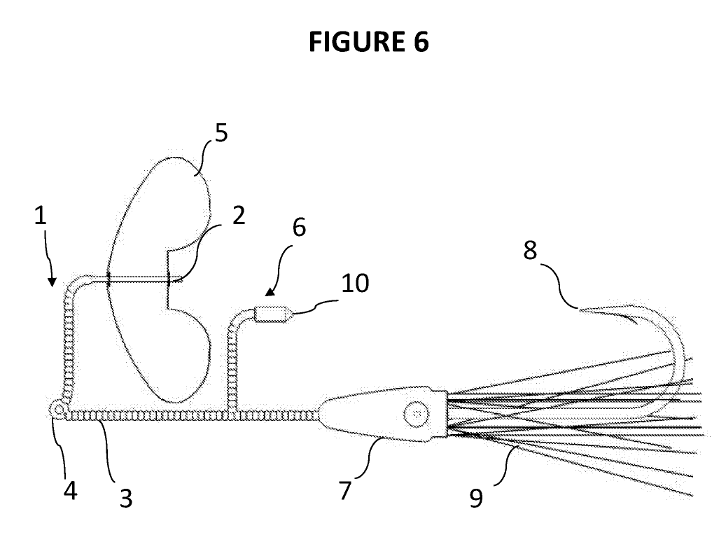

Referring to FIG. 6, an alternate embodiment of the buzz bait lure exists where the keeper 6 is affixed to the lower frame member 3, rather than the upper frame member 2, which it is integrated into in the preferred embodiment. In the alternate embodiment, the keeper 6 could be affixed to the lower frame member 3 in any manner known to those skilled in the art, including welding and soldering.

While the alternate embodiment would have all of the performance of the preferred embodiment, integrating the keeper 6 into the upper frame member 2 is preferred because it is simpler to manufacture, without having to weld or solder, and results in a more durable final product, because there are no weak points such as the weld, which are vulnerable to failure.

It would be appreciated by those skilled in the art that various changes and modifications can be made to the illustrated embodiments without departing from the spirit of the present invention. All such modifications and changes are intended to be covered by the appended claims.

What is claimed is:

1. A buzz bait lure comprising:
a means for receiving one end of a fishing line located at the forward end of the lure;
a frame, including upper and lower frame members, which extend rearwardly from said means for receiving one end of a fishing line eye in a diverging relationship where the upper and lower frame members will eventually run parallel to each other;
a one or more spinner blades, which are rotatably attached to said upper frame member;
a fish hook, which extends rearwardly from said lower frame member;
and a keeper, incorporating a means to secure live or artificial bait to the keeper, where the rearward most point of the keeper is point vertically oriented between the said upper and said lower frame members;
whereas said hook and said keeper are aligned with each other such that buzz bait lure can be baited with a live or artificial bait where the live or artificial bait is attached to the buzz bait lure at said keeper and said hook.

2. The buzz bait lure of claim 1, wherein said frame is comprised of wire that is substantially wrapped in colored strands of plastic which has been heated to affix the plastic to the wire frame.

3. The buzz bait lure of claim 2, wherein said stranded plastic is utilized as one or more of said spinner bearings to position the spinner blade on said upper frame member.

4. The buzz bait lure of claim 1, wherein a said keeper is integrated into said upper frame member, and protrudes rearward and downward from the said buzz blade.

5. The buzz bait lure of claim 1, wherein a said keeper is attached into said lower frame member, and protrudes rearward and upward from the said lower frame member.

6. The buzz bait lure of claim 1, further comprising a weighted bait body affixed to said lower frame member and said hook.

7. The buzz bait lure of claim 6, further comprising stranded filaments affixed to said weighted bait body.

8. 1. A buzz bait lure comprising:
a means for receiving one end of a fishing line located at the forward end of the lure;
a frame, including upper and lower frame members, which extend rearwardly from said means for receiving one end of a fishing line eye in a diverging relationship where the upper and lower frame members will eventually run parallel to each other;
a one or more spinner blades, which are rotatably attached to said upper frame member;
a fish hook, which extends rearwardly from said lower frame member;
wherein said frame is comprised of wire that is substantially wrapped in colored strands of plastic which has been heated to affix the plastic to the wire frame.

9. The buzz bait lure of claim 8, wherein said stranded plastic is utilized as one or more of said spinner bearings to position the spinner blade on said upper frame member.

10. The buzz bait lure of claim 9, further comprising a weighted bait body affixed to said lower frame member and said hook.

11. The buzz bait lure of claim 10, further comprising stranded filaments affixed to said weighted bait body.
